(19) United States
(12) Patent Application Publication
(10) Pub. No.: US 2009/0314042 A1
(43) Pub. Date: Dec. 24, 2009

(54) Door Lock With Large Handle

(76) Inventor: FangChang Fan, Tianjin (CN)

Correspondence Address: LIN & ASSOCIATES INTELLECTUAL PROPERTY, INC., P.O. BOX 2339, SARATOGA, CA, 95070-0339, US

(21) Appl. No.: 12/144,636

(22) Filed: Jun. 24, 2008

(51) Int. Cl. E05B 57/00

(52) U.S. Cl. 70/141

(57) ABSTRACT

A door lock having a large handle is provided, in which the door lock includes an inner lock portion, an outer lock portion and a lock bolt. The outer lock portion includes a transmission case and a cover, which define a receiving space therein for receiving an inner actuating plate engaged with an inner transmission wheel, and an outer actuating plate engaged with an outer transmission wheel. When the inner actuating plate moves upward, the outer actuating plate is caused to move upward, driving the outer transmission wheel to rotate counterclockwise. When the inner transmission wheel rotates counterclockwise, the outer transmission wheel is caused to rotate counterclockwise. When the key button is pushed downward, the outer actuating plate is caused to move upward, driving the outer transmission wheel to rotate counterclockwise. When the outer transmission wheel rotates counterclockwise, the lock bolt is caused to retract to unlatch the door.

### BACKGROUND OF THE INVENTION

1. Field of the Invention

The present invention generally relates to a door lock, and more particularly to a door lock with a large handle.

2. The Prior Arts

Currently available door locks having a large handle may have either of the following two constructions. As shown in FIG. 6, one conventional type of construction for the door lock may comprise an inner lock portion 17, an outer lock portion 1301 and a lock bolt 16. In this door lock structure, an outer key button 7 and a large handle 134′ is provided on the outer lock portion 1301. The large handle 134′ is securely assembled on the outer lock portion 1301. Through toothed wheel engagement, the outer key button 7 drives a drive shaft 1403 that passes through a cam 1610 of the lock bolt 16 to penetrate the inner lock portion 17. When the outer key button 7 is pushed down, the drive shaft 1403 is therefore driven in rotation to unlatch the door. While the lock bolt retracts into the lock bolt case, a reposition spring 172′ in the inner lock portion 17 is loaded, increasing the required pressure action on the outer key button 7. This repeated loading of the reposition spring 172′ during operation adversely reduces the life span of the door lock.

FIG. 7 is a perspective view of another conventional type of construction known for a door lock with a large handle. As shown, the door lock comprises the inner lock portion 17, the outer lock portion 1301 and the lock bolt 16. Two drive shafts 1401 and 1402 are provided on the outer lock portion 1301, and a lock bolt cam 1610 is provided on the lock bolt 16. During operation, the two drive shafts 1401 and 1402 simultaneously insert into the lock bolt cam 1610 to drive the lock bolt 16 in movement. Driving the lock bolt 16 respectively from both inner and outer sides does not create interference. However, this type of construction still has some disadvantages. In particular, because two drive shafts are used to control the operation of the lock bolt from both inner and outer sides, the length of the two drive shafts usually needs to be adjusted when the thickness of the door varies to ensure that the two drive shafts properly insert into the lock bolt cam in a simultaneous manner. This may be a cumbersome task for the user.

### SUMMARY OF THE INVENTION

The present invention provides a door lock with a large handle that is simple in construction and convenient to operate.

The door lock includes an inner lock portion, an outer lock portion and a lock bolt, in which the outer lock portion has a large handle and a handle base. The outer lock portion mainly includes a transmission case having a drive shaft hole; a cover adapted to attach on the transmission case to form a receiving space, in which the cover has a through hole; an inner actuating plate and an outer actuating plate respectively disposed in the receiving space, in which the inner actuating plate comprises a first rib, a central region of the inner actuating pate has a row of inner teeth adapted to engage with an inner transmission wheel, a top surface of the inner transmission wheel has a first wedge-shaped protuberance, and the outer actuating plate comprises a second rib corresponding to the first rib, a central region of the outer actuating plate has a row of outer teeth adapted to engage with an outer transmission wheel, a bottom surface of the outer transmission wheel has a second wedge-shaped protuberance that abuts against the first wedge-shaped protuberance; a drive shaft having a front end securely fixed with a square drive hole of the inner lock portion, a rear end respectively passing through the through hole of the cover, a rotary axle hole of a rotary axle, a through hole of the outer transmission wheel, a through hole of the inner transmission wheel, and the drive shaft hole of the transmission case, in which the rear end of the drive shaft is securely fixed with the inner transmission wheel and is able to rotate through the through hole of the outer transmission wheel, and the outer transmission wheel comprises a mount hub having a through hole corresponding to the rotary axle; and a key button having a drive surface that passes through the handle base and abuts against with a lower surface of the outer actuating plate.

A separator plate is disposed between the inner actuating plate and the outer actuating plate, a central region of the separator plate has a recess through which the inner actuating plate and the outer actuating plate are disposed, and a bottom of the separator plate includes a plurality of support lugs that connect with a bottom of the transmission case.

A lower end of the outer actuating plate comprises a tab extending perpendicular to the outer actuating plate.

Each of two shoulder portions of the outer actuating plate respectively comprises a stud, and a reposition spring is respectively disposed between each stud and a top inner wall of the transmission case.

The transmission case comprises at least two fastener catches, the cover comprises a plurality of slots corresponding to the fastener catches, the fastener catches adapted to insert through the slots to attach the cover on the transmission case.

The inner transmission wheel further comprises a hub provided with a hole passing therethrough, and the rear end of the drive shaft has a cylindrical shape provided with a cut portion corresponding to the hole through the hub, the cut portion being adapted to pass through the hole of the hub.

The rear end of the drive shaft comprises a retainer slot, the rear end passes through the inner transmission wheel and the drive shaft hole of the transmission case, and being securely fixed via a fastener engaging with the retainer slot.

The through hole in the mount hub of the outer transmission wheel has a square shape, and a cross-section of the rotary axle has a square shape corresponding to the through hole in the mount hub.

The cover comprises at least two through holes, the handle base has a plurality of threaded holes corresponding to the two through holes of the cover, and fixing bolts pass the through holes in the cover and threadly engage with the threaded holes in the handle base.

The cover comprises a plurality of matching holes corresponding to the positioning holes of the lock bolt, support nuts have matching ends passing through the positioning holes of the lock bolt to fit in corresponding matched holes on the cover.

With the door lock of the present invention, the lock bolt can be unlatched respectively from the inner lock portion and outer lock portion to open the door. When the lock bolt is unlatched by actuating the key button from the outer lock portion, the reposition spring in the inner lock portion is not deformed, which improves the life span of the door lock and prevents the conventional problems of requiring an excessive force for opening the door owing to a deformation of the reposition spring. Additionally, unlike the conventional approach that uses two rotary axles respectively inserting into the lock bolt cam to drive the lock bolt in movement, the door lock according to the present invention simply uses one rotary axle to drive the lock bolt in movement. Therefore, when the thickness of the door varies, adjustment of the lengths of the two rotary axles is no longer necessary.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is an exploded view showing an outer lock portion of a door lock having a large handle according to one embodiment of the present invention;

FIG. 1A is a perspective view showing an inner transmission wheel provided in a transmission case of the door lock according to an embodiment of the present invention;

FIG. 1B is a perspective view showing an outer transmission wheel provided in the transmission case of the door lock according to an embodiment of the present invention;

FIG. 1C is a perspective view showing an opposite side of the outer transmission wheel of FIG. 1 B;

FIG. 2 is a perspective view showing the door lock having the large handle according to one embodiment of the present invention;

FIG. 3A is a front view showing the outer lock portion of the door lock when the key button is in a downwardly pushed position according to one embodiment of the present invention;

FIG. 3B is a side view showing the outer lock portion of the door lock when the key button is in a downwardly pushed position according to one embodiment of the present invention;

FIG. 3C is a perspective view showing the outer lock portion of the door lock when the key button is in a downwardly pushed position according to one embodiment of the present invention;

FIG. 4A is a front view showing the outer lock portion of the door lock when the inner lock portion is turned clockwise according to one embodiment of the present invention;

FIG. 4B is a front view showing the outer lock portion of the door lock without an outer actuating plate when the the inner lock portion is turned clockwise according to one embodiment of the present invention;

FIG. 4C is a perspective view showing the outer lock portion of the door lock when the inner lock portion is turned clockwise according to one embodiment of the present invention;

FIG. 5A is a front view showing the outer lock portion of the door lock when the inner lock portion is turned counterclockwise according to one embodiment of the present invention;

FIG. 5B is a front view showing the outer lock portion of the door lock without the outer actuating plate when the inner lock portion is turned counterclockwise according to one embodiment of the present invention;

FIG. 5C is a perspective view showing the outer lock portion of the door lock when the inner lock portion is turned counterclockwise according to one embodiment of the present invention;

FIG. 6 is a perspective view of a conventional door lock having a large handle; and

FIG. 7 is a perspective view of another conventional door lock having a large handle.

### DETAILED DESCRIPTION

The following description in conjunction with the accompanying drawings set forth embodiments for achieving a door lock provided with a large handle.

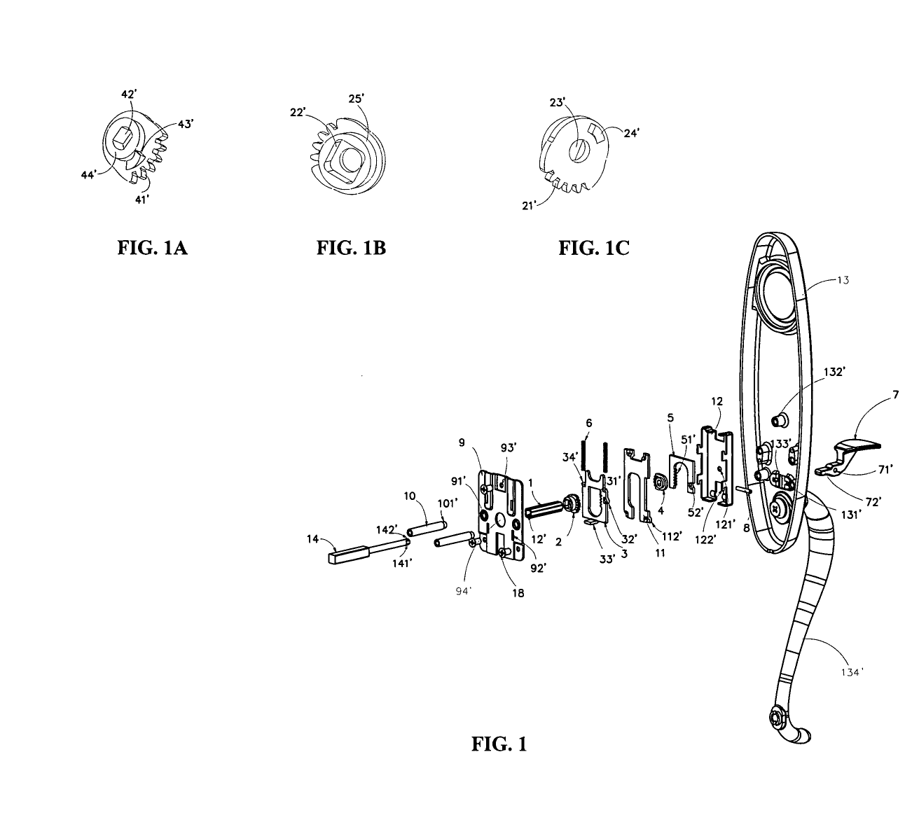

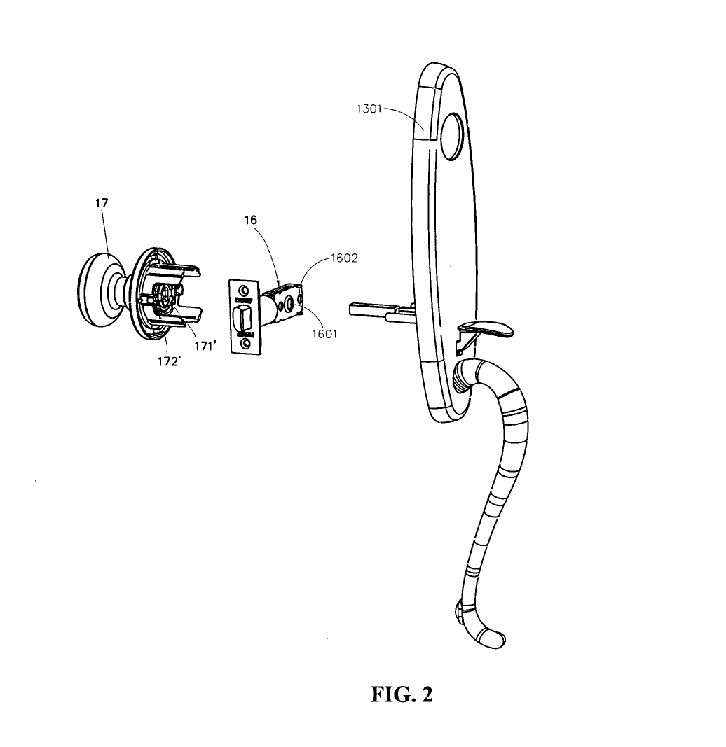

As shown in FIGS. 1 and 2, a door lock with a large handle according to one embodiment of the present invention comprises an outer lock portion 1301, a lock bolt 16, and an inner lock portion 17. The inner lock portion 17 comprises a knob and a transmission element. The inner lock portion 17 has a square drive hole 171′ adapted to receive a front end of a drive shaft 14 of the outer lock portion 1301. When inserted into the square drive hole 171′, the front end of the drive shaft 14 needs to pass through a drive hole 1601 of the lock bolt 16. The drive shaft 14 and square drive hole 171′ have corresponding shapes so that when the knob rotates, the square drive hole 171′ drives the drive shaft 14 in rotation.

In addition, the inner lock portion 17 also includes a reposition spring 172′ adapted to exert a restoring force after the knob has been rotated to cause the knob to recover its initial position.

At two sides of the drive hole 1601, the lock bolt 16 further includes two positioning holes 1602 in which support nuts 10 of the outer lock portion 1301 are inserted to assemble the lock bolt 16.

The outer lock portion 1301 comprises a handle base 13 on which a large handle 134′ is fixed. A key button 7 is provided above the large handle 134′. A rear end of the key button 7 is located on an outer side of the handle base 13, and a front end of the key button 7 passes through a square hole 133′ of the handle base 13. A through hole 71′ is provided on a central region of the key button 7, and corresponding grooves 131′ are also provided on the large handle 13. A transverse pin 8 passes through the through hole 71′ and have two ends thereof respectively received in the grooves 131′, so that the key button 7 can be pivoted upward and downward about the transverse pin 8. A front end of the key button 7 has a drive surface 72′ that abuts against a lower surface of an outer actuating plate 3.

The handle base 13 is provided with at least two threaded holes 132′ in which fixing bolts 18 passing through threaded holes 93′ of the cover 9 are engaged to securely fix the cover 9 on the handle base 13.

The outer lock portion 1301 further comprises the following elements.

A transmission case 12 has a rectangular slotted structure with four bent sides. A central portion of the transmission case 12 has a drive shaft hole 121′. The four bent sides are provided with at least two fastener catches adapted to pass through attachment slots provided on the cover 9 to securely fix the cover 9. As shown in FIG. 1, two vertical sidewalls of the transmission case 12 are provided with four L-shaped fastener catches 122′ that respectively pass through corresponding slots 92′ on the cover 9 to fix the cover 9.

The cover 9 attaches on the transmission case 12 to form a receiving space. A central area of the cover 9 includes a through hole 94′ located at a position that corresponds to the drive shaft hole 121′ on the transmission case 12. In addition, the cover 9 is provided with two matching holes 91′ adapted to fit with matching portions 101′ of the support nuts 10, which also pass through the positioning holes 1602 of the lock bolt 16.

The receiving space formed by the cover 9 and the transmission case 12 also includes an inner actuating plate 5, an inner transmission wheel 4, the outer actuating plate 3, and outer transmission wheel 2. Each of these elements is further described below.

The inner actuating plate 5 comprises a row of inner teeth 51′ adapted to engage with the inner transmission wheel 4. As shown in FIG. 1, the inner actuating plate 5 may have a U-shape, the row of inner teeth 51′ being arranged on an inner edge of one side extension of the U-shape. A rib 52′ also projects from a surface of the inner actuating plate 5 for abutting against a corresponding rib 32′ provided on the outer actuating plate 3. When the inner actuating plate 5 moves upward, the rib 52′ abuts against the rib 32′, thereby causing the outer actuating plate 3 to also move upward.

As shown in FIG. 1A, the inner transmission wheel 4 has a protruded shape structure. One edge of the inner transmission wheel 4, having otherwise a generally rounded shape, is provided with inner teeth 41′. In addition, a support hub 44′ having a cylindrical shape protrudes from a surface of the inner transmission wheel 4. A central area of the support hub 44′ includes a hole 42′. Furthermore, The surface of the inner transmission wheel 4 from which the support hub 44′ protrudes also comprises a protuberance 43′. The protuberance 43′ has a wedged shape that gradually increases in height along the circumference of the inner transmission wheel 4. More particularly, when viewed from a side facing the support hub 44′, the protuberance 43′ has a shape that gradually increases in height along an counterclockwise direction.

As shown in FIGS. 1B and 1C, the outer transmission wheel 2 also has a protruded shape structure. One edge of the outer transmission wheel 2, having otherwise a generally rounded shape, is provided with outer teeth 21′. In addition, the outer transmission wheel 2 includes a mount hub 25′ that has a central area provided with a through hole having a size corresponding to the outer contour of a rotary shaft 1. In this embodiment, the rotary shaft 1 has a hollow square shape. Therefore, the through hole on the mount hub 25′ is formed as a corresponding square hole 22′. Furthermore, a central area of the outer transmission wheel 2 also has a through hole 23′. The through hole 23′ has a circular shape and is located on an opposite side of the square hole 22′. On an opposite side of the mount hub 25′, the outer transmission wheel 2 includes a protuberance 24′. The protuberance 24′ has a wedged shape that gradually increases in height along the circumference of the outer transmission wheel 2. More particularly, when viewed from a side facing the mount hub 25′, the protuberance 24′ has a shape that gradually increases in height along a clockwise direction.

Referring to FIG. 1 again, a central region of the outer actuating plate 3 includes a row of teeth, row of outer teeth 31′, adapted to engage with the outer teeth 21′ of the outer transmission wheel 2. As a result, when the outer transmission wheel 2 rotates, the outer actuating plate 3 will accordingly move upward or downward. As described previously, the key button 7 when moved upward/downward drives upward/downward movement of the outer actuating plate 3, which causes the outer transmission wheel 2 to rotate either clockwise or counterclockwise.

In this embodiment, a lower surface of the outer actuating plate 3 can also include a tab 33′ arranged perpendicular to the body of the outer actuating plate 3. The drive surface 72′ of the key button 7 can thereby abut against the tab 33′, which increases the contact surface area and improves work reliability.

The outer actuating plate 3 when being driven by the key button 7 moves upward. Based on its own weight, the outer actuating plate 3 may also reversely move downward. However, relying on the sole weight for the downward movement cannot warranty the location and speed of the downward movement, which may affect the operation of the door lock. Therefore, in this embodiment, two shoulder portions of the outer actuating plate 3 are respectively provided with a stud 34′. When the outer actuating plate 3 is located in the receiving space formed by the cover 9 and transmission case 12, a reposition spring 6 placed between each stud 34′ and a top inner wall of the transmission case 12 can interact with the outer actuating plate 3 and cause it to quickly recover its initial position. In this manner, a correct operation of the door lock is ensured.

The outer lock portion 1301 further includes a drive shaft 14. A front end of the drive shaft 14 inserts into the square drive hole 171′ of the inner lock portion 17 to be secured therein. When the knob of the inner lock portion 17 rotates, the drive shaft 14 is driven in rotation. A rear end of the drive shaft 14 has a cylindrical shape that passes through the through hole 94′ of the cover 9, a rotary axle hole 12′ of the rotary shaft 1, the circular through hole 23′ of the outer transmission wheel 2, the hole 42′ of the inner transmission wheel 4, and drive shaft hole 121′ on the transmission case 12. The cylindrical rear end of the drive shaft 14 passing through the rotary axle hole 12′ and the circular through hole 23′ of the outer transmission wheel 2 is enabled to freely rotate relative to these holes. However, the cylindrical rear end of the drive shaft 14 is securely mounted through the hole 42′ of the inner transmission wheel 4 so that no rotation is enabled therebetween. Practically, a radial cut portion 141′ may be provided on the rear end portion of the drive shaft 14 corresponding to the hole 42′. The radial cut portion 141′ engages in the hole 42′ so as to securely fix the drive shaft 14 with the inner transmission wheel 4.

In order to prevent accidental disengagement of the drive shaft 14, the rear end of the drive shaft 14 further includes a retainer slot 142′ that is able to secure with a fastener piece having a corresponding shape after the rear end of the drive shaft 14 is inserted through the inner transmission wheel 4 and the drive shaft hole 121′ of the transmission case 12. The drive shaft 14 is thereby prevented from accidental disengagement.

In the aforementioned door lock structure, a separator plate 11 is also provided between the inner actuating plate 5 and the outer actuating plate 3. The separator plate 11 isolates the inner actuating plate 5 from the outer actuating plate 3 to prevent undesirable interaction when the inner actuating plate 5 and outer actuating plate 3 are moving relative to each other, which would affect the operation of the door lock. A central area of the separator plate 11 is provided with a recess for receiving the inner transmission wheel 4 and outer transmission wheel 2. In addition, a bottom end of the separator plate 11 has lugs 112′ that couple with the bottom of the transmission case 12 to securely fix the separator plate 11.

To achieve the present invention, embodiments for assembling the door lock are described hereinafter.

Referring to FIGS. 1 and 2 again, for assembling the outer lock portion 1301, the transmission case 12 is first assembled. After the inner actuating plate 5 and inner transmission wheel 4 in engagement are placed in the transmission case 12, the separator plate 11 is then mounted over with the lugs 112′ abutting against the bottom surface of the transmission case 12. To achieve a correct assembly, movement of the inner actuating plate 5 and inner transmission wheel 4 must be suitably permitted inside transmission case 12.

Next, the outer actuating plate 3 and outer transmission wheel 2 in engagement are placed in the transmission case 12. At this stage, the outer transmission wheel 2 is closely fit on the support hub 44′ of the inner transmission wheel 4, the protuberance 24′ engages with the protuberance 43′, and the rib 32′ on the outer actuating plate 3 engages with the rib 52′ of the inner actuating plate 5.

The stud 34′ on the outer actuating plate 3 abuts against the reposition spring 6, which has its opposite end connected with the inner wall of the transmission case 12.

After the rotary shaft 1 is inserted in the square hole 22′ of the mount hub 25′, the cylindrical rear end of the drive shaft 14 is passed through the rotary axle hole 12′, the circular through hole 23′ of the outer transmission wheel 2, and the hole 42′ of the inner transmission wheel 4, respectively. The rear end portion of the drive shaft 14 provided with the retainer slot 142′ then extends out of the drive shaft hole 121′ and is secured with a fastener element. At this stage, the cut portion 141′ of the drive shaft 14 fully inserts into the hole 42′.

Next, the support nuts 10 are secured on the cover 9 so that its matching portions 101′ fit into their respective matching holes 91′. The cover 9 is then put in place over the transmission case 12, and the fastener catches 122′ on the transmission case 12 are passed through the corresponding slots 92′ on the cover 9 and are then bent to tightly press thereon. The assembly of the transmission case 12 is thereby completed.

The key button 7 is inserted from the outer side into the square hole 133′ of the handle base 13. After the transverse pin 8 is passed from the interior of the handle base 13 through the through hole 71′, the two ends of the transverse pin 8 are respectively mounted in their corresponding grooves 131′ on the handle base 13, which thereby securely mounts the key button 7.

Lastly, the above assembled transmission case is secured on the handle base 13 using fixing bolts 18 engaging threaded holes 132′ of the handle base 13. At this stage, the tab 33′ at the lower end of the outer actuating plate 3 is in close contact with the drive surface 72′ at the front end of the key button 7. The assembly of the outer lock portion 1301 is thereby completed.

After the drive shaft 14 is mounted through the drive hole 1601 of the lock bolt 16, the two positioning holes 1602 of the lock bolt 16 are respectively inserted into the support nuts 10. The front end of the drive shaft 14 is then mounted through the square drive hole 171′ of the inner lock portion 17, which thereby completes the assembly of the door lock.

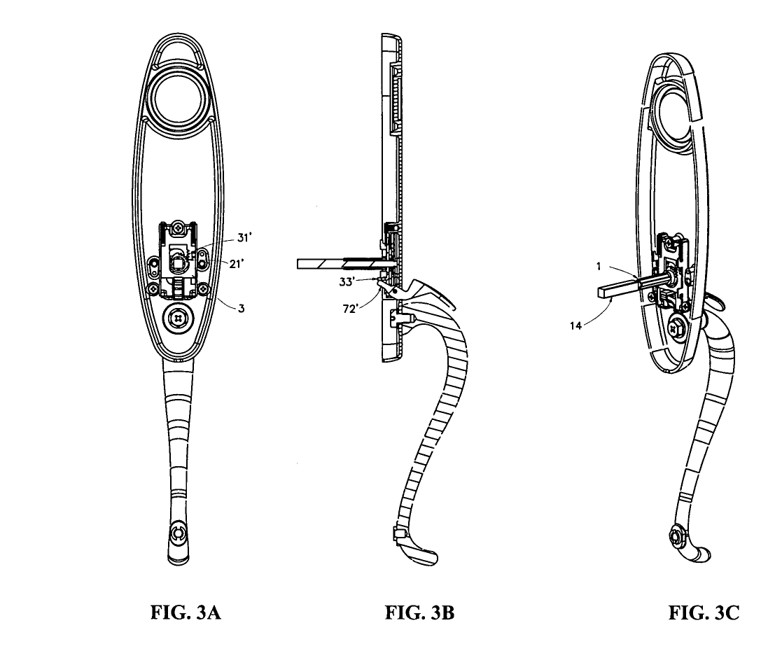

Reference is now made to FIGS. 3A-3C, 4A-4C, and 5A-5C to describe the operation of the door lock.

FIGS. 3A, 3B and 3C show the door lock of the present invention having the key button 7 in a downwardly pushed position. As shown, when the key button 7 is pushed downward, the drive surface 72′ interacts with the tab 33′ to cause the outer actuating plate 3 to move upward. Consequently, the engagement between the row of outer teeth 31′ and the outer teeth 21′ causes the outer transmission wheel 2 to rotate, and then via the square hole 22′ causes the rotation of the rotary axle 1 to unlatch the door that can then be opened. It is noted that the rib 32′ on the outer actuating plate 3 when being mounted is located above the rib 52′ of the inner actuating plate 5. Therefore, when the outer actuating plate 3 moves upward, the inner actuating plate 5 is prevented from moving upward. In other words, in the above operation, only the outer actuating plate 3, the outer transmission wheel 2 and rotary axle 1 are moving, whereas the inner actuating plate 5, the inner transmission wheel 4 and the drive shaft 14 remain stationary. In this manner, when the key button on the outer lock portion is actuated to open the door, the reposition spring 172′ in the inner lock portion does not receive any external force, which advantageously increases the life span of the door lock. In addition, when the outer key button is actuated, problems related to excessive force for opening the door due to the action of the reposition spring 172′ in the inner lock portion can be prevented.

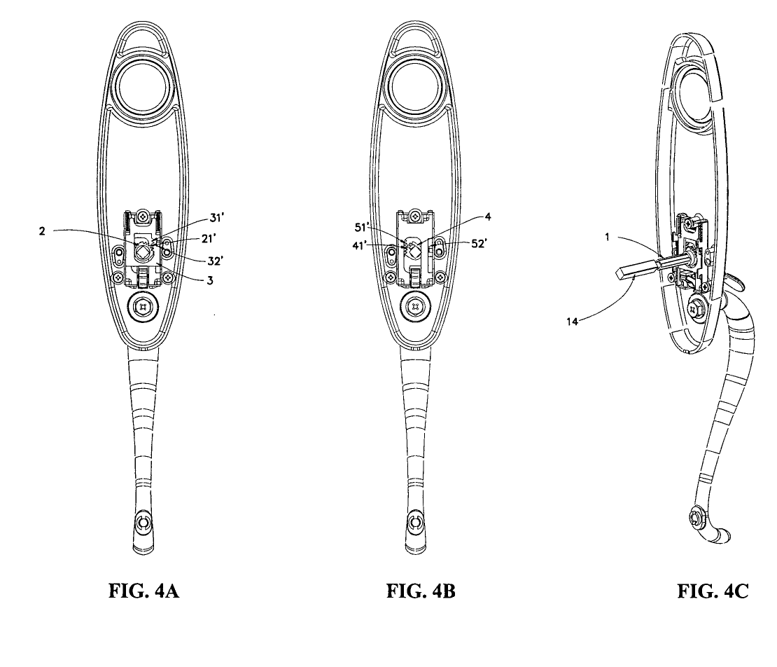

FIGS. 4A, 4B and 4C show the door lock of the present invention when the knob in the inner lock portion is turned clockwise. As shown, when the knob is turned clockwise, the square drive hole 171′ in the inner lock portion 17 drives the drive shaft 14 in rotation. Because the rear end of the drive shaft 14 has a cylindrical shape that can freely rotate through the through hole 23′ of the outer transmission wheel 2, the rotating drive shaft 14 does not drive the outer transmission wheel 2 in rotation. Moreover, as the cut portion 141′ on the rear end of the drive shaft 14 engages with the hole 42′ of the inner transmission wheel 4, the clockwise rotation of the drive shaft 14 also causes the inner transmission wheel 4 to rotate clockwise. As a result, owing to the engagement between the inner teeth 41′ of the inner transmission wheel 4 and the row of inner teeth 51′ of the inner actuating plate 5, the inner actuating plate 5 is caused to move upward. Through the contact between the rib 52′ of the inner actuating plate 5 and the corresponding rib 32′ on the outer actuating plate 3, the outer actuating plate 3 is also caused to move upward. Lastly, the row of outer teeth 31′ on the outer actuating plate 3 moves upward to cause the outer transmission wheel 2 to counterclockwise rotate, whereas the rotary axle 1 inserted through the square hole 22′ of the outer transmission wheel 2 also rotates counterclockwise. As a result, the lock bolt is caused to retract to unlatch the door.

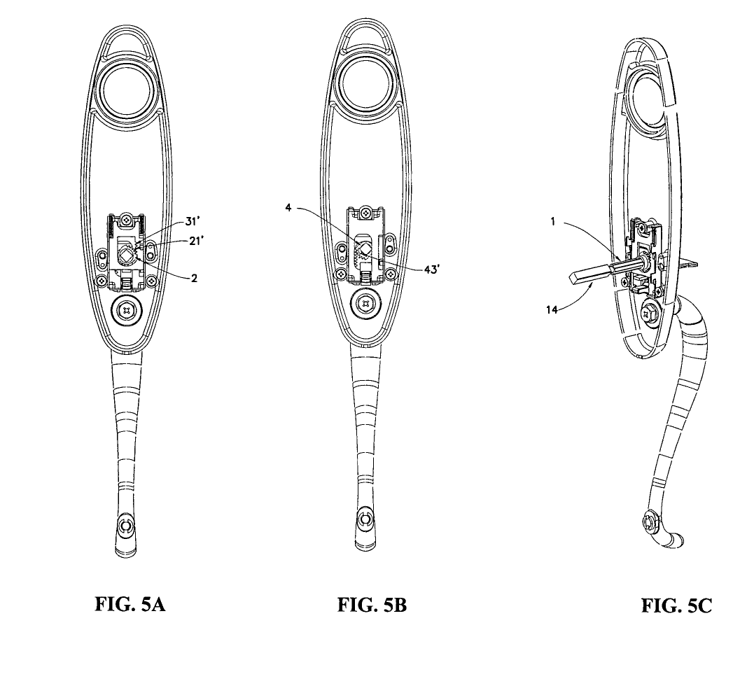

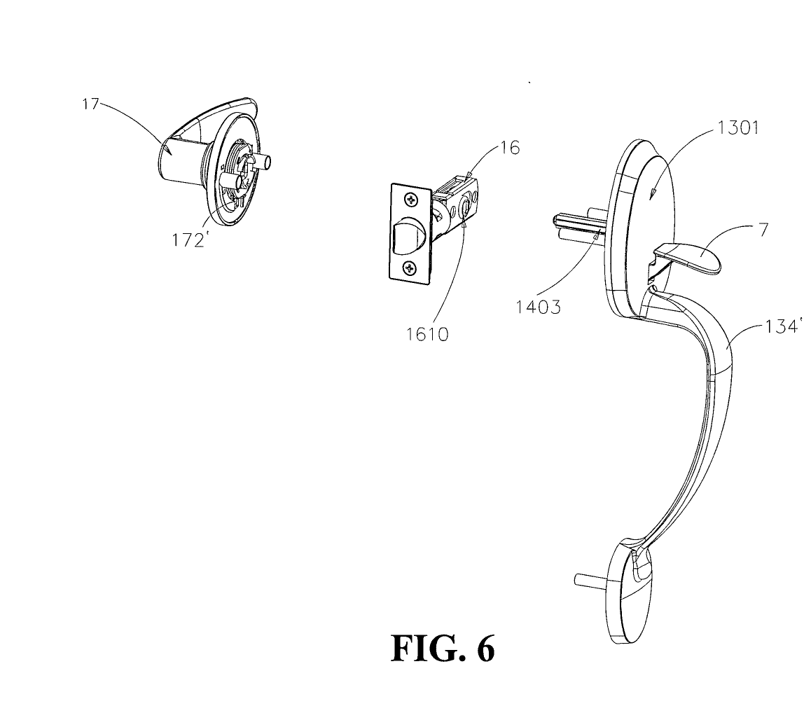

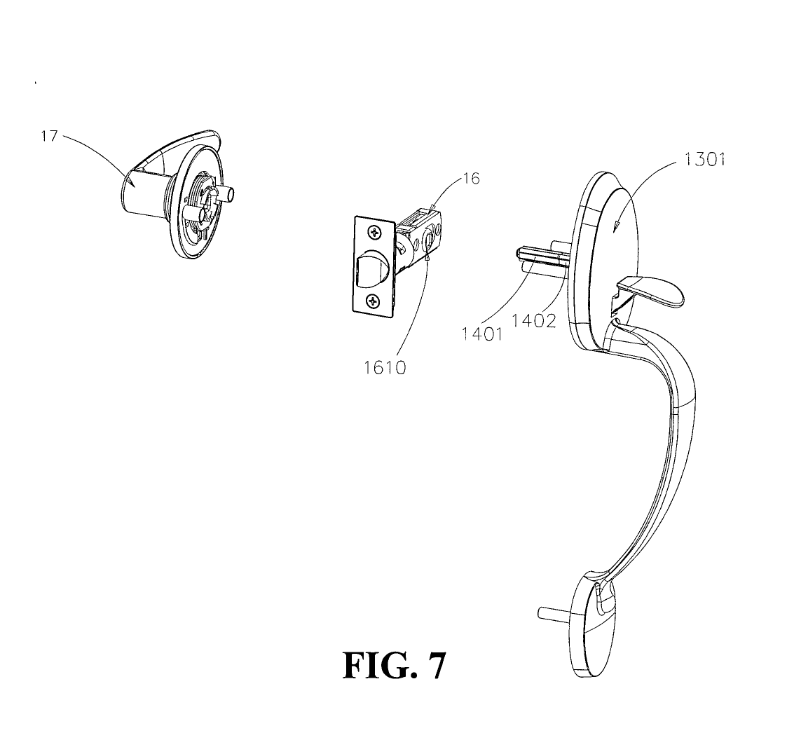

FIGS. 5A, 5B and 5C show the door lock of the present invention when the knob in the inner lock portion is turned counterclockwise. As shown, when the knob is turned counterclockwise, the inner transmission wheel 4 connected with the rear end of the drive shaft 14 also rotates counterclockwise. Because the protuberance 43′ on the inner transmission wheel 4 and the protuberance 24′ on the outer transmission wheel 2 contacts with each other, the counterclockwise rotation of the inner transmission wheel 4 causes the protuberance 43′ to apply an additional pressing force on the protuberance 24′, urging the outer transmission wheel 2 to rotate counterclockwise. As a result, the rotary axle 1 inserted through the square hole of the outer transmission wheel also rotates counterclockwise and causes the lock bolt to retract, which unlatches the door.

With the door lock according to the present invention, the lock bolt thus can be unlatched respectively from the inner lock portion and outer lock portion to open the door. When the lock bolt is unlatched by actuating the key button from the outer lock portion, the reposition spring 172′ in the inner lock portion is not deformed, which improves the life span of the door lock and prevents the conventional problems of requiring an excessive force for opening the door owing to a deformation of the reposition spring 172′. In addition, unlike the conventional approach that uses two rotary axles respectively inserting the lock bolt cam to drive the lock bolt in movement, the door lock according to the present invention simply uses one rotary axle to drive the lock bolt in movement. Therefore, when the thickness of the door varies, adjustment of the length of the two rotary axles is no longer necessary.

While the foregoing is directed to embodiments of the present invention, other and further embodiments of the invention may be devised without departing from the basic scope thereof, and the scope thereof is determined by the claims that follow.

What is claimed is:

1. A door lock having a large handle, wherein the door lock comprises an inner lock portion, an outer lock portion and a lock bolt, the outer lock portion comprises the large handle and a handle base, and the outer lock portion comprising:
a transmission case having a drive shaft hole;
a cover adapted to attach on the transmission case to form a receiving space, the cover having a through hole;
an inner actuating plate disposed in the receiving space and comprising a first rib, a central region of the inner actuating pate having a row of inner teeth adapted to engage with an inner transmission wheel, a top surface of the inner transmission wheel having a first wedge-shaped protuberance;
an outer actuating plate disposed in the receiving space and comprising a second rib corresponding to the first rib, a central region of the outer actuating plate having a row of outer teeth adapted to engage with an outer transmission wheel, a bottom surface of the outer transmission wheel having a second wedge-shaped protuberance that abuts against the first wedge-shaped protuberance;
a drive shaft having a front end securely fixed with a square drive hole of the inner lock portion, a rear end respectively passing through the through hole of the cover, a rotary axle hole of a rotary axle, a through hole of the outer transmission wheel, a through hole of the inner transmission wheel, and the drive shaft hole of the transmission case,
wherein the rear end of the drive shaft is securely fixed with the inner transmission wheel and is able to rotate through the through hole of the outer transmission wheel, the outer transmission wheel comprises a mount hub having a through hole corresponding to the rotary axle; and
a key button having a drive surface that passes through the handle base and abuts against with a lower surface of the outer actuating plate.

2. The door lock as claimed in claim 1, wherein a separator plate is disposed between the inner actuating plate and the outer actuating plate, a central region of the separator plate has a recess through which the inner actuating plate and the outer actuating plate are disposed, and a bottom of the separator plate includes a plurality of support lugs that connect with a bottom of the transmission case.

3. The door lock as claimed in claim 2, wherein a lower end of the outer actuating plate comprises a tab extending perpendicular to the outer actuating plate.

4. The door lock as claimed in claim 2, wherein each of two shoulder portions of the outer actuating plate respectively comprises a stud, and a reposition spring is respectively disposed between each stud and a top inner wall of the transmission case.

5. The door lock as claimed in claim 2, wherein the transmission case comprises at least two fastener catches, the cover comprises a plurality of slots corresponding to the fastener catches, the fastener catches adapted to insert through the slots to attach the cover on the transmission case.

6. The door lock as claimed in claim 2, wherein the inner transmission wheel further comprises a hub provided with a hole passing therethrough, and the rear end of the drive shaft has a cylindrical shape provided with a cut portion corresponding to the hole through the hub, the cut portion being adapted to pass through the hole of the hub.

7. The door lock as claimed in claim 6, wherein the rear end of the drive shaft comprises a retainer slot, the rear end passing through the inner transmission wheel and the drive shaft hole of the transmission case, and being securely fixed via a fastener engaging with the retainer slot.

8. The door lock as claimed in claim 2, wherein the through hole in the mount hub of the outer transmission wheel has a square shape, and a cross-section of the rotary axle has a square shape corresponding to the through hole in the mount hub.

9. The door lock as claimed in claim 2, wherein the cover comprises at least two through holes, the handle base has a plurality of threaded holes corresponding to the two through holes of the cover, fixing bolts pass the through holes in the cover and threadly engage with the threaded holes in the handle base.

10. The door lock as claimed in claim 2, wherein the cover comprises a plurality of matching holes corresponding to positioning holes of the lock bolt, and support nuts have matching ends passing through the positioning holes of the lock bolt to fit in corresponding matched holes on the cover.
